(19) United States
(12) Patent Application Publication
(10) Pub. No.: US 2024/0029010 A1
(43) Pub. Date: Jan. 25, 2024

(54) System And Method for Assisted Pick-Up and Delivery of Traveler Goods

(71) Applicant: OSCAR ERNESTO MUNOZ, Mountain View, CA (US)

(72) Inventor: OSCAR ERNESTO MUNOZ, Mountain View, CA (US)

(21) Appl. No.: 17/867,840

(22) Filed: Jul. 19, 2022

(51) Int. Cl. G06Q 10/08; G06Q 10/02; G06Q 50/30

(52) U.S. Cl. CPC G06Q 10/0835; G06Q 10/0833; G06Q 10/02; G06Q 50/30

(57) ABSTRACT

A system and method for assisted pick-up and delivery of goods, the method including downloading an enterprise application to a computer device; registering at an enterprise platform with the enterprise application; requesting a service pick-up and drop-off with said enterprise platform; scheduling an assisted pick-up of the luggage or package; confirming the pick-up of the luggage or package at the pick-up point assigned by said enterprise platform; scheduling an assisted delivery of the luggage or package; and confirming delivery of the luggage or package at the drop-off point assigned by said enterprise platform.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to a system and method for delivery of goods. More particularly, certain embodiments of the invention relate to a system and method for direct delivery of goods both domestic and/or international using a centralized platform.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Systems and methods for delivering goods/packages have seen a sea change over the years—including personal delivery, couriers—using different transport modes, and the like. However, to this day the cost of delivery may at times be far more than the cost of the package/goods being delivered. Accordingly, making the known systems and methods at times prohibitive for senders/receivers of the packages/goods. The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that recent methods published to ease the delivery of packages/goods typically include connecting and balancing desirable users and travelers by substituting one another in a trusted community, coordinating the delivery of packages by travelers which may include providing shipment data servers storing traveler records associated with potential travelers and providing said data to a sender who may then coordinate with the traveler; a computer-implemented approach for managing and delivering customer owned items; etc. In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a system for an airport direct express drop shipping by a sender in accordance with an embodiment of the present invention;

FIG. 2 illustrates a system for an airport direct express drop shipping by a traveler in accordance with an embodiment of the present invention;

FIG. 3 illustrates a system for an airport direct express drop shipping by a sender in accordance with an embodiment of the present invention;

FIG. 4 illustrates a system for an airport shipping in accordance with an embodiment of the present invention;

FIG. 5 illustrates an architecture of an exemplary system for an airport shipping in accordance with an embodiment of the present invention;

FIG. 6 is a process flow chart illustrating an airport direct express drop shipping by a sender in accordance with an embodiment of the present invention;

FIG. 7 is a process flow chart illustrating an airport direct express drop shipping by a traveler in accordance with an embodiment of the present invention;

FIG. 8 is a process flow chart illustrating an airport direct express drop shipping by a sender with an assigned traveler in accordance with an embodiment of the present invention;

FIG. 9 is a process flow chart illustrating an airport shipping in accordance with an embodiment of the present invention;

FIG. 10 is a block diagram depicting an exemplary client/server system which may be used by an exemplary web-enabled/networked embodiment of the present invention; and

FIG. 11 illustrates a block diagram depicting a conventional client/server communication system.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [”substantially“] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearward most point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. August 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said, “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred, or induced by any pattern(s) of description, embodiments, examples, or referenced prior art that may (or may not) be provided in the present patent.

References to “end user”, or any similar term, as used herein, is generally intended to mean late-stage user(s) as opposed to early-stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache. . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C . . . sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus, in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java.™., Jini.™., C, C++, Smalltalk, Perl, UNIX Shell, Visual Basic or Visual Basic Script, Virtual Reality Markup Language (VRML), ColdFusion.™. or other compilers, assemblers, interpreters or other computer languages or platforms.

Computer program code for carrying out operations for aspects of the present invention may be written in any combination of one or more programming languages, including an object-oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as web pages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods, and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods, and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a device. Such a medium may take many forms, including but not limited to, non-volatile media, volatile media, and transmission media. Non-volatile media include, for example, optical or magnetic disks and other persistent memory. Volatile media include dynamic random-access memory (DRAM), which typically constitutes the main memory. Transmission media include coaxial cables, copper wire and fiber optics, including the wires that comprise a system bus coupled to the processor. Transmission media may include or convey acoustic waves, light waves, and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards, or protocols, such as Bluetooth, TDMA, CDMA, 3G.

Where databases are described, it will be understood by one of ordinary skills in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CIFS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM.®. MQSeries.®. technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor-based memory, phase change memory, optical memory, periodically refreshed memory, and the like; the non-transitory computer readable medium, however, does not include a pure transitory signal per se; i.e., where the medium itself is transitory.

Embodiments of the invention disclosed herein relate to a system and method for delivery of goods. More particularly the system and method disclosed herein provide for direct delivery of goods both domestic and/or international using a centralized platform, at times referred to herein as an enterprise platform. In various embodiments, the system and method connect the senders, travelers, and receivers directly with a transportation authority such as, but not limited to, airlines, ships, buses, trains, ride providers, etc.

Herein, the term or terms goods may be to indicate any item, package, luggage, baggage, document, and the like. The enterprise platform may include a computer program comprising various information required of the various users of the platform including the sender, the traveler, the airline, the delivery assistants, and the receiver.

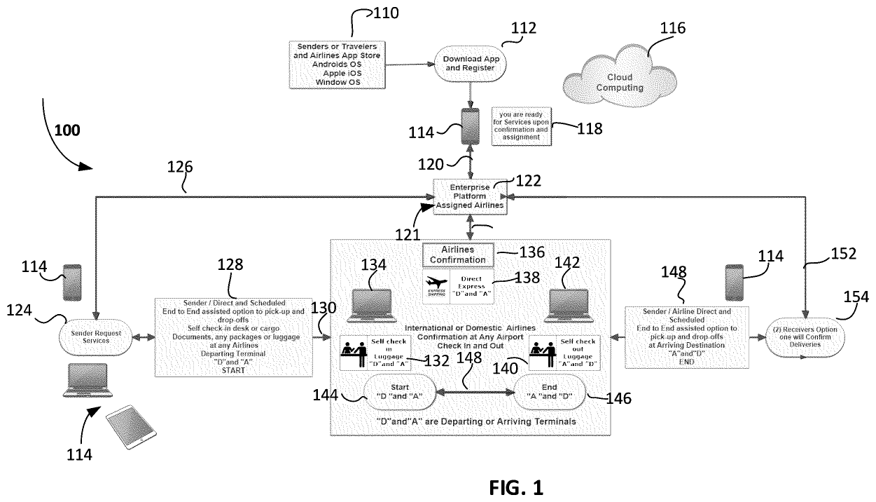

In an exemplary embodiment, referring to FIG. 1, is illustrated a system for an airport direct express drop shipping by a sender in accordance with an embodiment of the present invention. Accordingly, as shown in FIG. 1, is provided a system and methodology that may offer a seamless and frictionless end to end service to a sender for domestic and/or international shipping at departing to arriving airport terminals through a centralized platform (a computing system), i.e., an Enterprise Platform, Senders Direct 1, and Departing to Arrival Terminal Drop Shipping Method (DATPDSM) “novel”

It may be appreciated by a person with ordinary skill in the art, in light of and in accordance with the teachings of the present invention, that the sender may have to access an application store 110 to download an application 112 to a computer device 114 to enable the sender to access the enterprise platform 122. In one embodiment, the sender may register with enterprise platform 122 to enable the sender access to the enterprise platform after downloading the application. Registration to the platform may be mandatory. Or the sender may log in as a guest and use the platform and logout for a one-time use. A sender profile and/or traveler profile may retain the user history. The sender may have a choice of choosing a traveler, airline, or any other feature. Also, the platform does the matching of sender-traveler-airline in the background based on sender requirement. Once the registration process is complete the sender is ready for receiving the services from the enterprise platform upon confirmation and assignment 118 There may be a payment involved in the registration/upon confirmation on assignment steps. The sender may have a choice to select from a list of airlines provided by the enterprise platform. The sender may state their requirement during the registration process and then the platform may provide the assignment. The sender may use the computer device 114 to be in active communication 120 with an airline assigned 121 by the enterprise platform 122 In one embodiment, the sender may request airlines assigned 121 by enterprise platform 122 for services 124 using the computer device 114 via a two-way communication 126 where required information may be exchanged between sender and assigned airlines via the enterprise platform. Senders may confirm and provide shipping content disclosure and liability release. In addition, personal information may be needed to be exchanged by the sender and/or airlines. In one embodiment the sender may directly i.e., personally drop 128 the goods at a departing terminal of the assigned airlines. Senders may have a choice to request for specific airlines and reassignment if assignment made by platform is unfavorable/unavailable based on sender requirements. It may be appreciated by a person with ordinary skill in the art, in light of and in accordance with the teachings of the present invention that the sender may either self-check in the goods at a desk or in the airlines cargo area at a departing terminal of an assigned airlines 128. In another embodiment, the sender may schedule an assisted pick-up and delivery of goods 128, which may be beneficial for individuals with handicap. In this manner, the handicapped individuals will get help instantly with picking up and delivery of their goods upon arrival at an airport In an exemplary embodiment 130 the sender may self-check in 132 the goods at a departure terminal 134 of an assigned international or domestic airlines 121 and receive confirmation 136 of checking in the goods with the airlines for regular delivery or direct express delivery of goods.

In one embodiment, the enterprise platform 122 may enable a traveler/receiver to self-checkout 140 the goods at an arrival terminal 142. Accordingly, the enterprise platform 122 may provide a user an end-to-end seamless delivery option which operates in working communication 148 starting 144 from an arrival or departure terminal and ending 146 at an arrival or departure terminal.

In one embodiment, the system 100 may enable the assigned airline 121 or sender to pick up 148 the goods at a claim or custom cargo area. In another embodiment, the system 100 may enable the assigned airline 122 to allow an authorized employee to pick up 148 the goods at an assisted drop delivery option at arriving destination. Once the goods are received by a receiver, the receiver may confirm delivery 154 of the goods using computer device 114 or Enterprise Platform 122. In one embodiment, the receiver's computer device 114 may also be in working communication with the assigned airlines 121 provided by the enterprise platform 122 to enable tracking of the goods sent by the sender via the airlines.

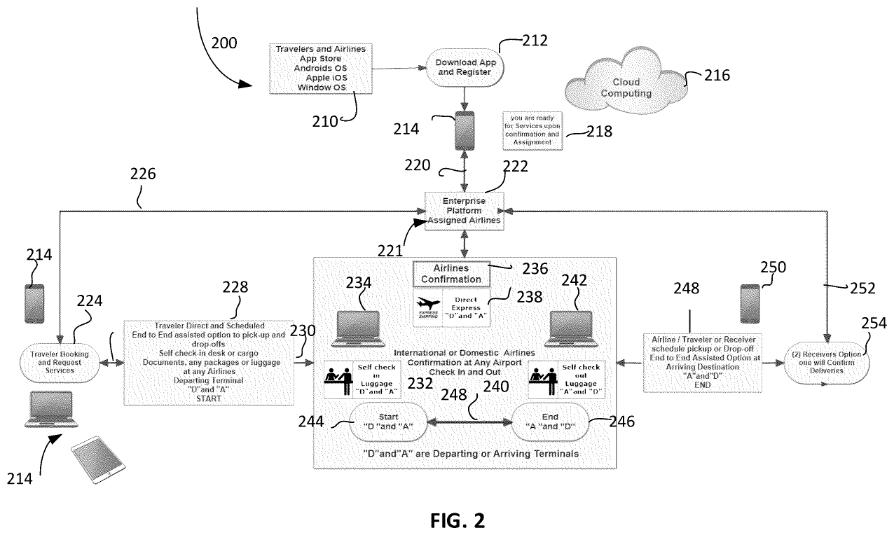

In an exemplary embodiment, referring to FIG. 2, is illustrated a system for an airport direct express drop shipping by a traveler in accordance with an embodiment of the present invention. Accordingly, as shown in FIG. 2, is provided a system and methodology that may offer a seamless and frictionless end to end service to a traveler for domestic and/or international shipping at departing to arriving airport terminals through a centralized platform, i.e., an enterprise platform, Departing to Arrival Terminal Drop Shipping Method (DATPDSM).

In an exemplary embodiment, the enterprise platform 222 may provide a traveler, sender, or receiver with an application to access the enterprise platform 222. It may be appreciated by a person with ordinary skill in the art, in light of and in accordance with the teachings of the present invention, that the traveler may have to access an application store 210 to download an application 212 to a computer device 214 to enable the traveler to access the enterprise platform 222. In one embodiment, the traveler may register with the enterprise platform 222 to enable the traveler access to the enterprise platform after downloading the application. During the registration process, the traveler may enter required or requested services, personal information, originating airport, destination airport, payment of fees, etc. Once the registration process is complete the traveler is ready for receiving the services from the enterprise platform 222 upon confirmation and assignment 218. The traveler may use the computer device 214 to be in active communication 220 with an airline 221 assigned by the enterprise platform 222. In one embodiment, the traveler may request an airlines assigned 221 by the enterprise platform 222 for services 224 using the computer device 214 via a two-way communication 226 where required information may be exchanged between traveler and assigned airlines via the enterprise platform including information that may be needed to be exchanged by traveler or Sender and Receiver Declaration of content Disclosure and or Manifesto and personal traveling documentation as Provided and requested by Custom and or airlines Departing and or Arriving Terminals. In one embodiment the traveler may directly i.e., personally drop 228 the goods at a departing terminal of the assigned airlines. Requesters may have a choice and request for specific airlines and reassignment if assignment made by platform is not based on traveler requirements. It may be appreciated by a person with ordinary skill in the art, in light of and in accordance with the teachings of the present invention that the traveler may either self-check in the goods at a desk or in the Cargo Desk area at a departing terminal of an assigned airline 228. In another embodiment, the traveler may schedule an assisted pick of goods 228, which may be beneficial for individuals with handicap. In this manner, handicapped individuals may get help instantly with picking up and delivery of their goods upon arrival at an airport without accumulating long lines especially during busy hours. In an exemplary embodiment 230 the traveler may self-check in 232 the goods at a departure terminal 234 of an assigned international or domestic airlines 221 and receive confirmation 236 of checking in the goods with the airlines for regular delivery or direct express delivery of goods.

In one embodiment, the enterprise platform 222 may enable a traveler to self-check 240 the goods at an arriving terminal 242. Accordingly, the enterprise platform provides a user an end-to-end seamless delivery option which operates in working communication 248 starting 244 from an arrival or departing terminal and ending 246 at an arrival or departing terminal.

In one embodiment, the system 200 may enable the assigned airline 221 or traveler to pick up 248 the goods at a claim or custom cargo area. In another embodiment, the system 200 enables the assigned airline 221 or traveler to pick up 248 the goods at an assisted drop delivery option at arriving destination. Once the goods are received by a receiver, the receiver may confirm delivery of 254 of the goods using a computer device 252. In one embodiment, the receiver's computer device 252 may also be in working communication with the assigned airlines 221 provided by the enterprise platform 222 to enable tracking of the goods sent by the sender via the airlines.

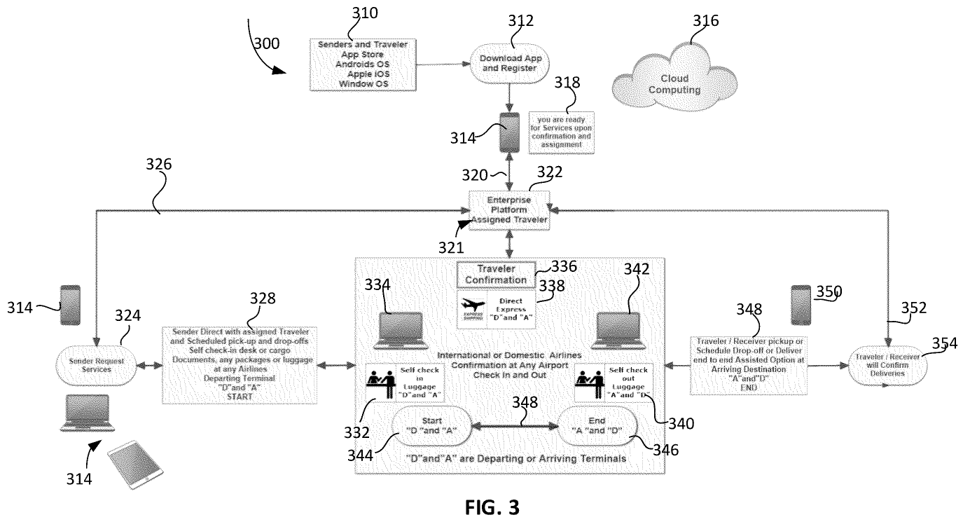

In an exemplary embodiment, referring to FIG. 3, is illustrated a system for an airport direct express drop shipping by a requester in accordance with an embodiment of the present invention. Accordingly, as shown in FIG. 3, is provided a system and methodology that may offer a seamless and frictionless end to end service to a requester with an assigned traveler for domestic and/or international shipping at departing to arriving airport terminals through a centralized platform, i.e., an enterprise platform 322. A requester may be a sender, receiver, another traveler, etc.

In an exemplary embodiment, the enterprise platform may provide a sender and a traveler with an application to access the enterprise platform 322. It may be appreciated by a person with ordinary skill in the art, in light of and in accordance with the teachings of the present invention, that the sender and the traveler may have to access an application store 310 to download an application 312 to a computer device 314 to enable the sender and traveler to access the enterprise platform. In one embodiment, the sender and the traveler may register with the enterprise platform to enable the sender and the traveler to access the enterprise platform after downloading the application. Registration may be mandatory. Or users may login and logout for a one-time use of the enterprise platform. There may be a payment involved in the registration/upon confirmation on assignment steps. The sender may state their shipping/delivery requirement during the registration process and then the assignment may be provided. Once the registration process is complete the sender and the traveler may be ready for receiving the services from the enterprise platform upon confirmation and assignment 318. The sender and/or traveler profile may retain the user history. The sender may use the computer device 314 to be in active communication 320 with a traveler assigned 321 by the enterprise platform 322. The sender may have a choice to select from a list of airlines provided by the enterprise platform. The enterprise platform alone may be responsible to make the connections between sender-traveler-airline-3^{rd} party receiver. In one embodiment, the sender may request a traveler assigned 321 by the enterprise platform 322 for services 324 using the computer device 314 via a two-way communication 326 where required information may be exchanged between the sender and the assigned traveler 321 via the enterprise platform 322. The Enterprise Platform will Assign and coordinate sender and traveler shipping documentation end to end arrangements. In one embodiment the sender with the assigned traveler may directly, i.e., personally drop 328 the goods at a departing terminal of any airline. Travelers may have a choice and request for specific airlines and reassignment if assignment made by platform is not based on traveler requirements. It may be appreciated by a person with ordinary skill in the art, in light of and in accordance with the teachings of the present invention that the sender with the assigned traveler may either self-check in the goods at a desk or in the desk cargo area at a departing terminal of an any airlines 328. In another embodiment, the sender with the assigned traveler may schedule an assisted pick of goods 328, which may be beneficial for individuals with handicap. In this manner, the handicapped individuals may get help instantly with picking up and delivery of their goods upon arrival at an airport and without causing delays or long lines to accumulate specially during airport busy hours The Enterprise Platform may assign and coordinate sender and traveler shipping documentation end to end arrangements. In an exemplary embodiment 330 sender with the assigned traveler may self-check in 332 the goods at a departure terminal 334 of any international or domestic airlines and receive confirmation 336 of checking in the goods with the airlines for direct express delivery of goods.

In one embodiment, the enterprise platform may enable a traveler to self-checkout 340 the goods at an arriving terminal 342 and hand deliver the goods to a receiver. Accordingly, the enterprise platform provides a user an end-to-end seamless delivery option which operates in working communication 348 starting 344 from an arrival or departing terminal and ending 346 at an arrival or departing terminal. In one embodiment, the system 300 may enable the assigned traveler 321 or a receiver to pick up 348 the goods at a claim or custom cargo area. In another embodiment, the system 300 may enable the assigned traveler 321 or a receiver to pick up 348 the goods at an assisted drop delivery option at arriving destination. Once the goods are received by a receiver, the traveler or the receiver may confirm delivery of 354 of the goods using a computer device 352. In one embodiment, the receiver's computer device 352 may also be in working communication with the assigned traveler 321 provided by the enterprise platform 322 to enable tracking of the goods sent by the sender via the airlines.

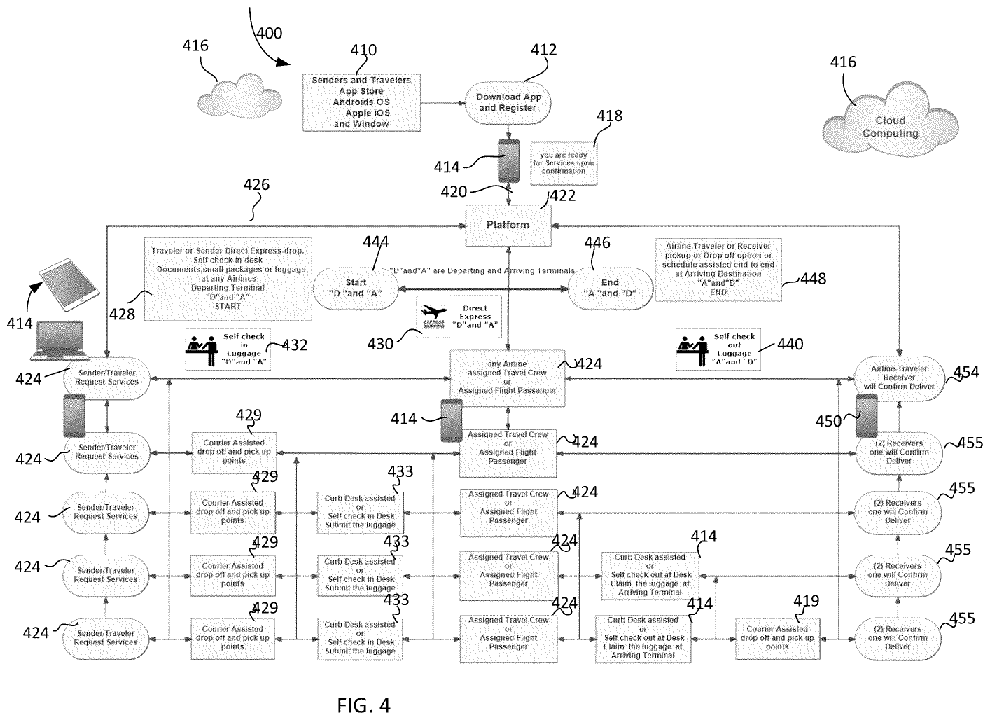

In an exemplary embodiment, referring to FIG. 4, is illustrated a system for an airport shipping in accordance with an embodiment of the present invention. Accordingly, as shown in FIG. 4, is provided a system and methodology that may offer a seamless and frictionless end to end service to a sender for domestic and/or international shipping at departing to arriving airport terminals through a centralized platform, i.e., an enterprise platform.

In an exemplary embodiment, the enterprise platform may provide a sender and a traveler an application to access the enterprise platform. It may be appreciated by a person with ordinary skill in the art, in light of and in accordance with the teachings of the present invention, that a plurality of senders, a plurality of travelers, a plurality of airlines, a plurality of delivery assistant providers, for example, couriers, curb desk assistors, self-check in desks, self-checkout desks etc. . . . may be provided by the enterprise platform 422. It may be appreciated by a person with ordinary skill in the art, in light of and in accordance with the teachings of the present invention, that the senders and the travelers may have to access an application store 410 to download an application 412 to a computer device 414 to enable the senders and travelers to access the enterprise platform 422.

In one embodiment, the sender and the traveler may register with the enterprise platform 422 to enable the sender and the traveler access to the enterprise platform after downloading the application. Or the sender and/or traveler may be provided a one-time use of the platform without registering. Once the registration process is complete the sender and the traveler may be ready for receiving the services from the enterprise platform upon confirmation and assignment 418. The sender and the traveler may use the computer device 414 to be in active communication 420 with enterprise platform 422. In one embodiment, the sender or the traveler may request any airline assigned travel crew or airline assigned flight passenger 424 via the enterprise platform 422 for services 424 using the computer device 414 via a two-way communication 426 where required information may be exchanged between the sender or the traveler with the assigned airline travel crew or passenger 424 via the enterprise platform 422. In one embodiment the sender or the traveler may directly, i.e., personally drop 428 the goods at a departing terminal of any airline. Assignments are made by the platform based on sender and or traveler requirements. It may be appreciated by a person with ordinary skill in the art, in light of and in accordance with the teachings of the present invention that the sender or the traveler may either self-check in the goods at a desk or in the cargo area documents at a departing terminal of any airlines 428. In another embodiment, the sender or the traveler may schedule a courier assisted drop off and pick up of goods 429, which may be beneficial for handicapped individuals and other travelers alike. In this manner, the handicapped individuals may get help instantly with picking up and delivery of their goods upon arrival at an airport and without causing delays to other travelers or long lines of travelers accumulating specially during airport busy hours In an exemplary embodiment the sender with the traveler may self-check in the goods at an airline desk or request for curb desk assisted check in the goods at an airline desk of a departure terminal 433 of any international or domestic airlines.

An assigned travel crew or assigned flight passenger 424 may be assigned by the airline selected to take the goods from the start terminal 444 (arrival or departure terminal) to the end terminal 446 (arrival or departure terminal) via direct seamless shipping 430. In one embodiment, the enterprise platform may enable 448 an airline, a traveler, or a receiver to pick up or drop off the goods or schedule an assisted end to end pickup and drop off of goods at arriving destination. In one embodiment, the traveler may self-checkout 440 goods at the arriving destination. In one exemplary embodiment, the enterprise platform 422 may enable 414 the traveler to claim the goods by scheduling a curb desk assistance or self-checkout at desk at the arriving terminal. In another exemplary embodiment, the enterprise platform 422 may enable 419 the traveler to schedule a courier assisted drop off and pick up points at the arriving terminal. Accordingly, the enterprise platform provides a user an end-to-end seamless delivery option which operates in working communication 430 starting 444 from an arrival or departing terminal and ending 446 at an arrival or departing terminal.

In one embodiment, the system 400 may enable the assigned traveler or a receiver to pick up 448 the goods at a claim or custom cargo area. In another embodiment, the system 400 may enable the assigned traveler or a receiver to pick up 448 the goods at an assisted drop delivery option at arriving destination. Once the goods are received by a receiver, the traveler or the receiver may confirm delivery 454 of the goods using a computer device 450.

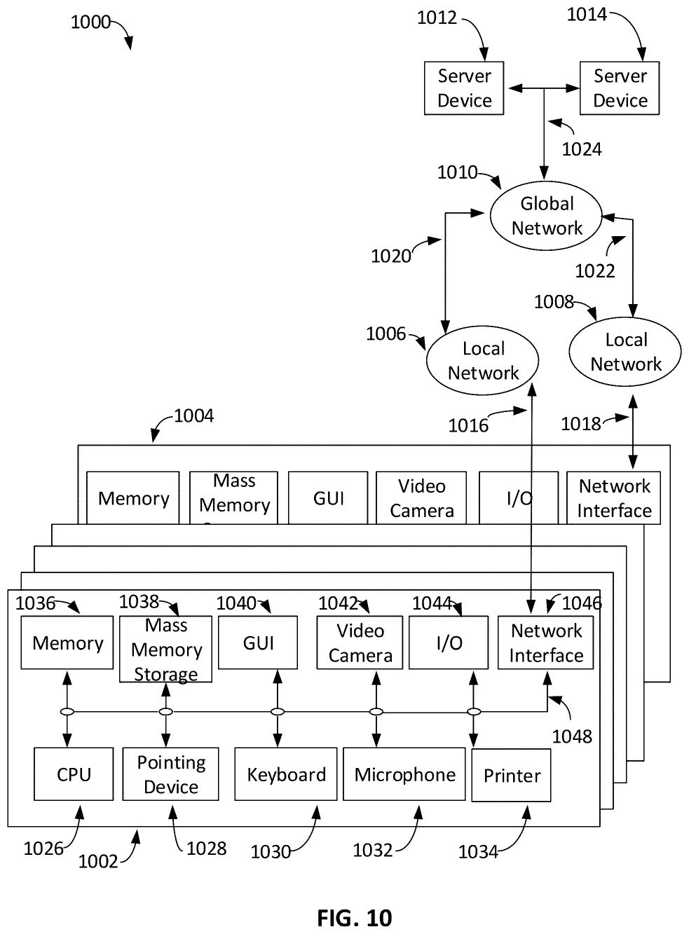

Turning back to FIG. 1, FIG. 2., FIG. 3, and FIG. 4, the systems 100, 200, 300 and 400 comprises at least one user i.e., either a sender, a traveler, an airline, and a receiver (not shown in figure), at least one computing system 116, 216, 316, 416 (shown as Global Network 1010 in FIG. 10), and at least a storage device (shown as Server Device 1012, 1014 in FIG. 10). The computing system 116, 216, 316, 416 may be in working communication with computer devices 114, 214, 314, 450, that may be used by the various users to access the computing system 116, 216, 316, and 416. The computer devices 114, 214, 314, 450, 134, 142, 234, 242, 334, 342 (shown as Client 1002, 1004 in FIG. 10), may include a display screen (GUI 1040), a database (1038), and a miscellaneous data input interface (1028, 1030, 1032, 1034, 1042, 1044). It may be appreciated by a person with ordinary skill in the art, in light of and in accordance with the teachings of the present invention, that the computer devices have been numbered for brevity. Each user that is a sender, a traveler, a receiver, and the airlines may have their own computer devices and use them for seeking the services provided by the enterprise platform.

During a typical operation of the system 100, 200, and 300 a user i.e., a sender, a traveler, or a sender with an assigned traveler respectively may request services for delivering goods from the enterprise platform 122, 222, 322 included in the computing system 116, 216, 316, respectively. The enterprise platform enables the users to download an application from an application store in the enterprise platform and register before making the service requests. Once the requests are made, as described herein above with reference to FIG. 1, FIG. 2, and FIG. 3, the users are able to send, deliver, and receive goods from a starting point to ending point seamlessly. The users may use direct pick up and drop of methods or schedule assisted pick up and drop offs using the systems 100, 200, and 300. The system 4 described with reference to FIG. 4 provides a combination of the services provided in systems 100, 200 and 300.

In an exemplary embodiment, the enterprise platform may include information on sender and receiver personal or business information, airline information provided by airlines as requested services, requirements for accessibility, app download and registration, payment modalities, optional alternatives services, user access levels control through platform. In various embodiments, the enterprise platform itself may house all the information or all the information may be in a cloud database in working communication with the enterprise platform, or the cloud database may double up as an enterprise platform. In an exemplary embodiment, an enterprise platform 122 may provide a sender with an application to access the enterprise platform.

Referring to FIGS. 1-4 and FIG. 10, in certain embodiments, user information i.e., information on the user and service requests made by the users may be gathered by the cloud computing system 116, 216, 316, 416 (shown as Global Network 1010 in FIG. 10) in a direct interaction with the user via the enterprise platform 122, 222, 322, 422 (shown as Server Device 1012, 1014 in FIG. 10) using the computer devices of the users 114, 214, 314, 450, 134, 142, 234, 242, 334, 342 (shown as Client 1002, 1004 in FIG. 10). In certain embodiments, the user information may be gathered by the computing system from another device that may have previously gathered and archived the user information. The other device may include a computing system similar to or different from that of the cloud computing system 116, 215. 316, 416. The miscellaneous data input interface 1030 1032 1034 1040 1042 1044 may interact with the user to gather any additional information on the user including but not limited to facial scan, retinal scan, fingerprint, and the like. The user information may be stored in a database 1038, 1012, 1014. The cloud computing system then processes and formats the user information, makes the relevant coordination, and provides the user with the airline, traveler, and delivery assistance, as described hereinabove to provide seamless delivery of goods from a start point to an end point.

It may be appreciated by a person with ordinary skill in the art, in light of and in accordance with the teachings of the present invention, referring to FIGS. 1-4 and FIG. 10, that the computing systems 116, 216, 316, and 416 (shown as Global Network 1010 in FIG. 10) and the computer device 114, 214, 314, 450, 134, 142, 234, 242, 334, 342 (shown as Client 1002, 1004 in FIG. 10), may include virtually any computer device capable of capturing, processing, and displaying user information and providing appropriate information and assistance to the user for delivering goods from a start point to an end point. Non-limiting examples of the computing systems 116, 216, 316, and 416 and computer devices 114, 214, 314, 450, 134, 142, 234, 242, 334, 342 include a computer 1002, 1004, and a smartphone 1002, 1004. The computing systems and the computer devices 1002, 1004 may include any computing platform 1026 that executes computer software and/or code from a non-transitory computer readable medium 1036, 1038. The computing systems and the computer devices may include a single device or multiple devices. In embodiments where the computing system and the computer device 1002 or 1004 is a single device all the functions of capturing the user information including user data 1030, face scan 1042, fingerprint scan 1034, information on goods to be delivered, delivery information, etc., may be executed by CPU 1026 of the single computing system and/or the computer device. In embodiments where the computing system and the computer device 1002, 1004 include multiple devices these functions may be distributed between the multiple devices. For example, the gathering of user service requests and goods delivery information may be done by one computer device and the gathering of user fingerprint scan may be done by another computer device. In another embodiment, the computer device is a single device, and the computer system is a single computer system.

Referring to FIGS. 1-4 and FIG. 10, it may be appreciated by a person with ordinary skill in the art, in light of and in accordance with the teachings of the present invention, that the cloud computing system 116, 216, 316, and 416 in the form of Global Network 1010 may connect to any number of devices with virtually any wired and/or wireless means 1016 1020 1024. The computing system may connect to virtually any device by means such as, but not limited to, Bluetooth connection, Ethernet cable, USB cable, WIFI, IRDA, etc. . . . In one embodiment, the cloud computing system 116, 216, 316, 416 may connect to other devices for gathering user information and delivery information.

It may be appreciated by a person with ordinary skill in the art, in light of and in accordance with the teachings of the present invention, a miscellaneous data input interface may be virtually any data input interface capable of capturing the user information and information on goods to be delivered. The computing system may include tools, for example, questionnaires which the user answers using the miscellaneous data input interface. The tools may be capable of gathering information on the user's preferences and the goods that are to be delivered. Non-limiting variables of user's preferences include a sender user being particular of how the goods should be delivered, or a traveler user being particular of what type of goods the traveler would like to deliver, etc. . . .

Referring to FIGS. 1-4 and FIG. 10, the database may be, but not limited to, a plurality of data servers 1012, 1014, and a memory card 1038. In certain embodiments, the cloud computing system 116, 216, 316, and 416 may function as the database. It may be appreciated by a person with ordinary skill in the art, in light of and in accordance with the teachings of the present invention, that the database (containing user's organized information) may contain virtually any user data to enable the enterprise platform 122, 222, 322, and 422 in the cloud computing systems 116, 216, 316, and 416 to assist a user in delivering goods form a start point to an end point.

It may be appreciated by a person with ordinary skill in the art, in light of and in accordance with the teachings of the present invention, the user information gathered may partially or completely be contained in a local computing platform and/or network. In an alternative embodiment of the present invention, the user information gathered may be located on a local computer network.

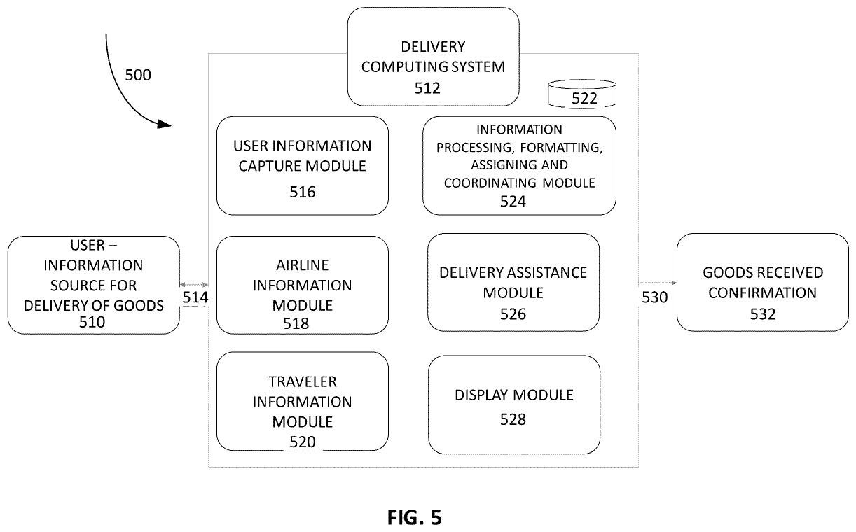

FIG. 5 illustrates an architecture of an exemplary system for providing a computerized seamless delivery of goods, in accordance with an embodiment of the present invention. Referring to FIGS. 1-5 and FIG. 10, architecture 500 may comprise a delivery computing system 512. The computing system 512 may run on the computer device 116, 216, 316, and 416 (shown as Global Network 1010 in FIG. 10), computing platform 114, 214, 314, 450, 134, 142, 234, 242, 334, 342 (shown as Client 1002, 1004 in FIG. 10), and/or Enterprise Platform 122, 222, 322, 422 (shown as Server Device 1012, 1014 in FIG. 10). The computing system 512 may include a user information capture module 516, an airline information module 518, a traveler information module 520, a database module 522, an information processing, formatting, assigning, and coordinating module 524, a delivery assistance module 526, and a display module 528. The user information capture module 516, may have a means of capturing user information 1030 1032 1034 1042 1044, such as, without limitation, gathers information using display 1040 of questions on the display module 528 i.e., a questionnaire for capturing user requirement and information of goods to be delivered which a sender/user answers using miscellaneous data capture device 1030 1032 1034 1042 1044, or capture information from a user using a speaker-recorder 1032, 1044 where the user (sender) listens and answers to a series of questions, etc., or capture visual information of goods to be delivered using a camera 1042, etc. for a user 510. The airline information module 518, may have a means of capturing airline information, such as, without limitation, airline itinerary, delivery statistics, safety statistics, etc., for a user 510. The traveler information module 520, may have a means of capturing the traveler information, without limitation, gathers information using display 1040 of questions on the display module 528 which the traveler answers using miscellaneous data capture device 1032, 1044, or gathers information using a speaker—recorder 1032, 1044 where the traveler listens and answers to a series of questions, etc. . . . The delivery assistance module 526, may have a means of capturing the information on delivery assisters like couriers, without limitation, gathers information using display 1040 of questions on the display module 528 which the delivery assistor answers using miscellaneous data capture device 1032, 1044, or gathers information using a speaker—recorder 1032, 1044 where the delivery assistor listens and answers to a series of questions, etc. . . . Information processing, formatting, assigning, and coordinating module 524 may have a means of processing the gathered information, such as, without limitation, a processing unit 1026, a computer 1002, 1004, or a server 1012 or 1014 to execute computer code and/or algorithms from a non-transitory computer readable medium 1036 or 1038 for coordinating goods delivery. A display module 528 may have a means to display 1040 the information gathered, the coordination of sender, traveler and airline, the delivery status, the receiver information, the receiver confirmation, etc. to a user. The database 522 may be, but not limited to, a plurality of data servers 1012, 1014, and a memory card 1036, 1038.

It may be appreciated by a person with ordinary skill in the art, in light of and in accordance with the teachings of the present invention, that one or more modules may be embodied in a single device. In an alternative embodiment of the present invention, all modules except the user information capture module may be embodied in a delivery computing system 512. The delivery computing system 512 may be capable of gathering information on the sender, the traveler, the receiver, and the goods to be delivered, processing, formatting, and organizing the information, coordinating the delivery schedule, and enabling the user to deliver the goods from a start point to an end point.

It may be appreciated by a person with ordinary skill in the art, in light of and in accordance with the teachings of the present invention, that there may be a plurality of the same modules in the delivery system architecture 500. A plurality of modules such as, without limitation, a user information capture module 516, an airline information module 518, a traveler information module 520, a database module 522, an information processing, formatting, assigning, and coordinating module 524, a delivery assistance module 526, and a display module 528 in the delivery system architecture 500. The plurality of similar modules may work in parallel or independently to improve the throughput and/or speed of delivery system architecture 500. In an alternative embodiment of the present invention, a plurality of capture, processing, formatting, and assigning, coordinating, display, and database modules may be connected to a delivery system via wired and wireless connections to access resources from different wired and wireless networks. In still another alternative embodiment of the present invention, a plurality of similar modules may form a secondary delivery system capable of seamlessly substituting an errant module.

It may be appreciated by a person with ordinary skill in the art, in light of and in accordance with the teachings of the present invention, that one or more modules may transmit capture information to a tech support server that is on an accessible network or over the internet. In an alternative embodiment of the present invention, additional captured information may be sent to a server to alleviate processing load on the delivery system, for example, if multiple deliveries are being organized at the same time.

It may be appreciated by a person with ordinary skill in the art, in light of and in accordance with the teachings of the present invention, that any module in architecture 500 may perform data manipulation. Data manipulation such as, but not limited to, compression, encryption, formatting. In an alternative embodiment of the present invention, any module sending data may first compress the data prior to data transmission.

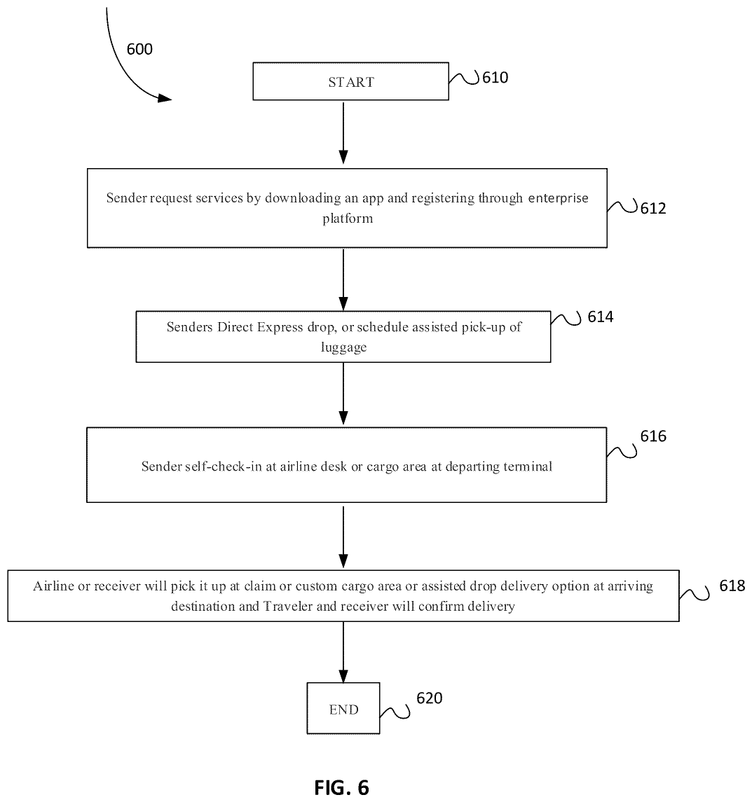

Referring to FIG. 6, is illustrated a process flow chart for an airport direct express drop shipping by a sender in accordance with an embodiment of the present invention. As shown in FIG. 6, a methodology of domestic and International shipping at departing to arriving airport terminals through an enterprise platform providing a seamless and frictionless end to end delivery service is provided. The process starts with a start step 610. In a second step 612 a sender may request services from an enterprise platform by downloading an application and registering through the enterprise platform. In a third step 614 the sender may directly drop the goods/luggage/baggage to a pick-up point or schedule an assisted pick-up of luggage or baggage at the pick-up point using the enterprise platform. In a fourth step 616 the sender may self-check in the goods at an airline desk or cargo area at a departing terminal of an airline assigned by the enterprise platform.

In a fifth step 618 the airline or receiver will pick the goods up at a claim or custom cargo area or at an assisted drop off delivery option at the arriving destination assigned to the Traveler and receiver will confirm delivery of the goods. In a sixth step 620 the process ends with the confirmation from the receiver.

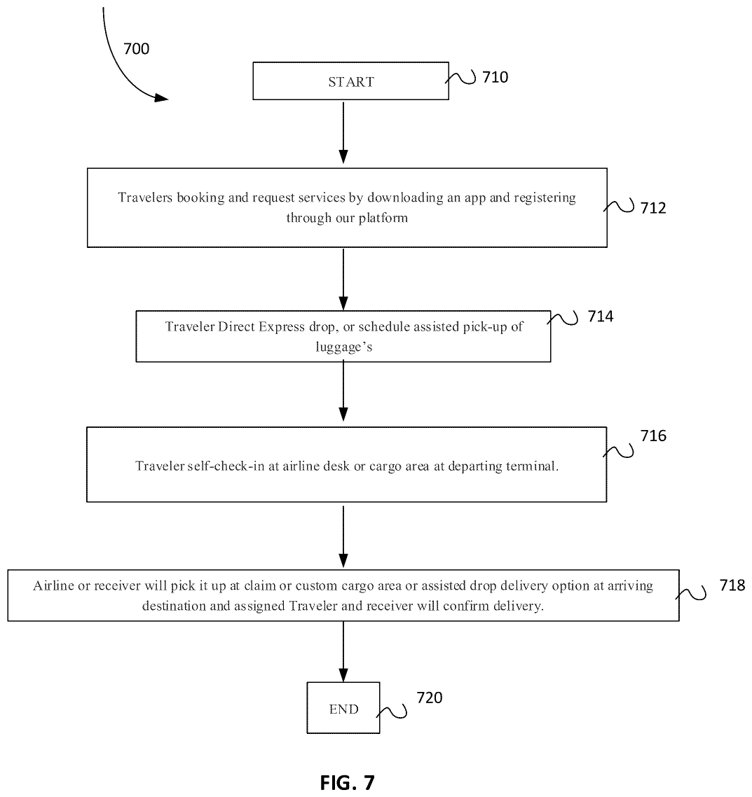

Referring to FIG. 7, is illustrated a process flow chart illustrating an airport direct express drop shipping by a traveler in accordance with an embodiment of the present invention. As shown in FIG. 7, a methodology of domestic and International shipping at departing to arriving airport terminals through an enterprise platform providing a seamless and frictionless end to end delivery service is provided. The process starts with a start step 710. In a second step 712 Travelers booking and request services by downloading an app and registering through the enterprise platform. In a third step 714 the traveler may directly drop the goods to a pick-up point or schedule an assisted pick-up of luggage or baggage at the pick-up point using the enterprise platform. In a fourth step 716 the sender may self-check in the good at an airline desk or Desk cargo area at a departing terminal of an airline assigned by the enterprise platform. In a fifth step 718 the airline or receiver will pick the goods up at a claim or custom cargo area or at an assisted drop off delivery option at the arriving destination assigned to the traveler and receiver will confirm delivery of the goods. In a sixth step 720 the process ends with the confirmation from the receiver.

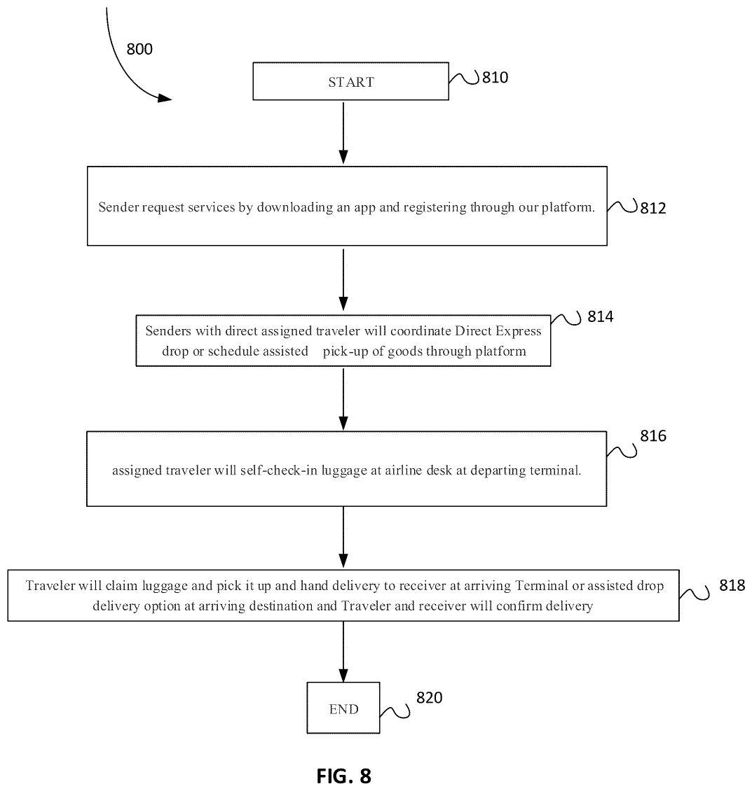

Referring to FIG. 8 is illustrated a process flow chart illustrating an airport direct express drop shipping by a sender with an assigned traveler in accordance with an embodiment of the present invention. As shown in FIG. 8, a methodology of domestic and International shipping at departing to arriving airport terminals through an enterprise platform providing a seamless and frictionless end to end delivery service is provided. The process starts with a start step 810. In a second step 812 Sender requests services by downloading an app and registering through the enterprise platform. In a third step 814 the Senders with direct assigned traveler will coordinate Direct Express drop or schedule assisted pick-up of goods using the enterprise platform. In a fourth step 816 the assigned traveler will self-check-in goods at an airline desk or cargo area at a departing terminal of an airline assigned by the enterprise platform. In a fifth step 818 travelers will claim goods and pick it up and hand deliver the goods to the receiver at arriving terminal or assisted drop delivery option at arriving destination and traveler and receiver will confirm delivery. In a sixth step 820 the process ends with the confirmation from the receiver.

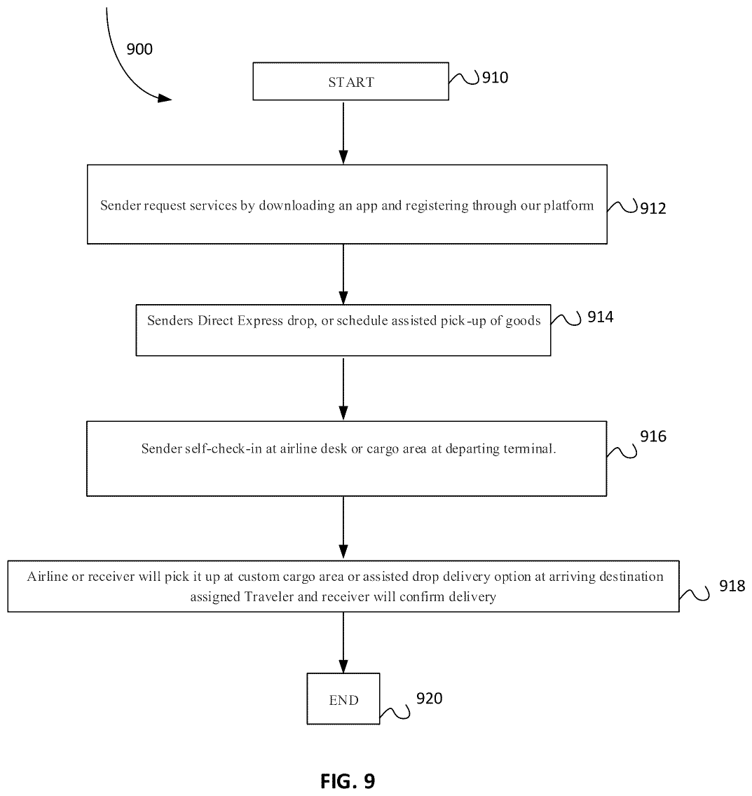

FIG. 9 is a process flow chart illustrating airport shipping in accordance with an embodiment of the present invention. It may be appreciated by a person with ordinary skill in the art, in light of and in accordance with the teachings of the present invention that, other features that are available in the art may be seamlessly integrated with the delivery system described herein to enable the sender with travelers, delivery assisters, package tracking, and the like. The other features may include, but are not limited to, crowdsourcing flying traveler's 24/7; with digital disruption market approach through apps for any kind of smartphone, affecting established business such; FedEx-DHL-UPS-USPS-incumbents; using a smartphone to communicate with sender/receiver such as WhatsApp, Facebook, Skype, and Face timing; application using tracking of GPS for traveler and package for both land and flying traveler; a customized platform revolution such Uber-Lyft-Airbnb; crowdsourcing of flying travelers for deliveries; crowdsourcing of land travelers for deliveries; associates or partners making delivery same day; option of insurance to make sure package makes it to drop off place safely; have a clearance level for any delivery such as background check; content disclosure; release of liability to sender due to content f package (business and traveler); documentation of package (content checklist); pickup and drop site location lists; fixed menu pricing and dynamic pricing; cloud based information available anytime anywhere for sender and receiver, and the like features. Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied. Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

FIG. 10 is a block diagram depicting an exemplary client/server system which may be used by an exemplary web-enabled and/or networked embodiment of the present invention, in accordance with an embodiment of the present invention.

A communication system 1000 includes a multiplicity of clients (e.g. computer device 114, 214, 314, or 414) with a sampling of clients denoted as a client 1002 and a client 1004, a multiplicity of airport terminals with a sampling of airport terminals denoted as a local network (e.g. arrival terminal) 1006 and a local network (e.g. departure terminal) 1008, a global network (e.g. Cloud Computing and/or Enterprise Platform) 1010 and a multiplicity of data servers with a sampling of data servers denoted as a server device 1012 and a server device 1014.

Client 1002 may communicate bi-directionally with local network 1006 via a communication channel 1016. Client 1004 may communicate bi-directionally with local network 1008 via a communication channel 1018. Local network 1006 may communicate bi-directionally with global network 1010 via a communication channel 1020. Local network 1008 may communicate bi-directionally with global network 1010 via a communication channel 1022. Global network 1010 may communicate bi-directionally with server device 1012 and server device 1014 via a communication channel 1024. Server device 1012 and server device 1014 may communicate bi-directionally with each other via communication channel 1024. Furthermore, clients 1002, 1004, local networks 1006, 1008, global network 1010 and server devices 1012, 1014 may each communicate bi-directionally with each other.

In one embodiment, global network 1010 may operate as the Internet that any airline or shipper, sender, traveler, receiver, etc. may access for communication such as but not limited to, data, voice, video, etc. It will be understood by those skilled in the art that communication system 1000 may take many different forms. Non-limiting examples of forms for communication system 1000 may include local area networks (LANs), wide area networks (WANs), Bluetooth connection, Ethernet cable, USB cable, WIFI, IRDA, wired telephone networks, wireless networks, or any other network supporting data communication between respective entities. Global network 1010 may include at least one or more networking devices configured to transfer information between the various networked elements, at least one or more server devices 1012, 1014 for executing software instructions, store information, support database operations and communicate with other networked elements. In addition, one or more server devices 1012, 1014 may operate as the enterprise platform and database.

Referring to FIGS. 1-4 and FIG. 10, clients 1002 and 1004 may take many different forms. Non-limiting examples of clients 1002 and 1004 may include computer devices, personal computers, personal digital assistants (PDAs), cellular phones and smartphones (e.g., 114, 214, 314, 414).

Clients 1002 and 1004 may include a CPU 1026, a pointing device 1028, a keyboard 1030, a microphone 1032, a printer 1034, a memory 1036, a mass memory storage 1038, a GUI 1040, a video camera 1042, an input/output interface 1044, and a network interface 1046.

Referring to FIG. 5 and FIG. 10, pointing device 1028, keyboard 1030, microphone 1032, printer 1034, video camera 1042, and input/output interface 1044 may be used by user information capture module 516. Memory 1036 and mass memory storage 1038 may be used by airline information module 518, traveler information module 520, database module 522. CPU 1026 may be used by information processing, formatting, assigning, and coordinating module 524.

CPU 1026, pointing device 1028, keyboard 1030, microphone 1032, printer 1034, memory 1036, mass memory storage 1038, GUI 1040, video camera 1042, input/output interface 1044 and network interface 1046 may communicate in a unidirectional manner or a bi-directional manner with each other via a communication channel 1048. Communication channel 1048 may be configured as a single communication channel or a multiplicity of communication channels.

CPU 1026 may comprise a single processor or multiple processors. CPU 1026 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general-purpose microprocessors.

As is well known in the art, memory 1036 is used typically to transfer data and instructions to CPU 1026 in a bi-directional manner. Memory 1036, as discussed previously, may include any suitable computer-readable media, intended for data storage, such as those described above excluding any wired or wireless transmissions unless specifically noted. Mass memory storage 1038 may also be coupled bi-directionally to CPU 1026 and provides additional data storage capacity and may include any of the computer-readable media described above. Mass memory storage 1038 may be used to store programs, data and the like and is typically a secondary storage medium such as a hard disk. It will be appreciated that the information retained within mass memory storage 1038, may, in appropriate cases, be incorporated in standard fashion as part of memory 1036 as virtual memory.

CPU 1026 may be coupled to GUI 1040. GUI 1040 enables a user to view the operation of computer operating systems and software. CPU 1026 may be coupled to pointing device 1028. Non-limiting examples of pointing device 1028 include computer mouse, trackball, and touchpad. Pointing device 1028 enables a user with the capability to maneuver a computer cursor about the viewing area of GUI 1040 and select areas or features in the viewing area of GUI 1040. CPU 1026 may be coupled to keyboard 1030. Keyboard 1030 enables a user with the capability to input alphanumeric textual information to CPU 1026. CPU 1026 may be coupled to microphone 1032. Microphone 1032 enables audio produced by a user to be recorded, processed, and communicated by CPU 1026. CPU 1026 may be connected to printer 1034. Printer 1034 enables a user with the capability to print information to a sheet of paper. CPU 1026 may be connected to video camera 1042. Video camera 1042 enables video produced or captured by the user to be recorded, processed, and communicated by CPU 1026.

CPU 1026 may also be coupled to input/output interface 1044 that connects to one or more input/output devices such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 1026 optionally may be coupled to network interface 1046 which enables communication with an external device such as a database or a computer or telecommunications or internet network using an external connection shown generally as communication channel 1016, which may be implemented as a hardwired or wireless communications link using suitable conventional technologies. With such a connection, CPU 1026 might receive information from the network, or might output information to a network in the course of performing the method steps described in the teachings of the present invention.

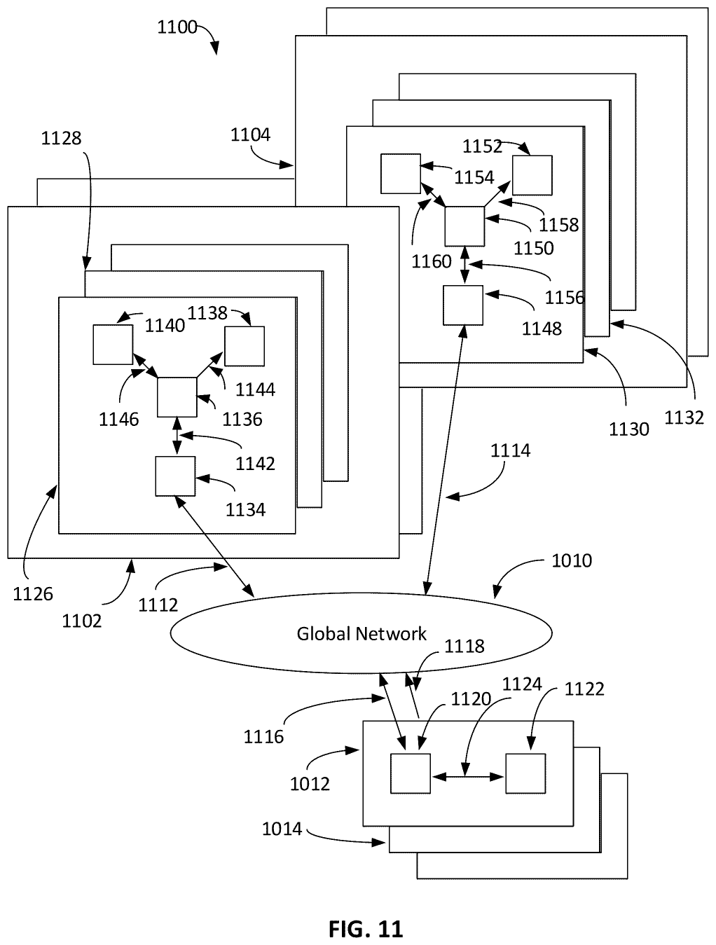

FIG. 11 illustrates a block diagram depicting a client/server communication system, which may be used by an exemplary web-enabled and/or networked embodiment of the present invention, in accordance with an embodiment of the present invention.

A communication system 1100 includes a multiplicity of networked regions with a sampling of regions denoted as a network region 1102 and a network region 1104, a global network 1010 and a multiplicity of servers with a sampling of servers denoted as a server device 1012 and a server device 1014.

Network region 1102 and network region 1104 may operate to represent a network contained within a geographical area or region. Non-limiting examples of representations for the geographical areas for the networked regions may include postal zip codes, telephone area codes, states, counties, cities, and countries. Elements within network regions 1102 and 1104 may operate to communicate with external elements within other networked regions or within elements contained within the same network region.

In some implementations, global network 1010 may operate as the Internet that any airline, sender, traveler, assistor, etc. may access for communication such as but not limited to, data, voice, video, etc. It will be understood by those skilled in the art that communication system 1100 may take many different forms. Non-limiting examples of forms for communication system 1100 include local area networks (LANs), wide area networks (WANs), wired telephone networks, cellular telephone networks or any other network supporting data communication between respective entities via hardwired or wireless communication networks. Global network 1010 may operate to transfer information between the various networked elements.

Server device 1012 and server device 1014 may operate to execute software instructions, store information, support database operations and communicate with other networked elements. Non-limiting examples of software and scripting languages which may be executed on server device 1012 and server device 1014 include C, C++, C#, and Java.

Network region 1102 may operate to communicate bi-directionally with global network 1010 via a communication channel 1112. Network region 1104 may operate to communicate bi-directionally with global network 1010 via a communication channel 1114. Server device 1012 may operate to communicate bi-directionally with global network 1010 via a communication channel 1116. Server device 1014 may operate to communicate bi-directionally with global network 1010 via a communication channel 1118. Network region 1102 and 1104, global network 1010 and server devices 1012 and 1014 may operate to communicate with each other and with every other networked device located within communication system 1100.

Server device 1012 includes a networking device 1120 and a server 1122. Networking device 1120 may operate to communicate bi-directionally with global network 1010 via communication channel 1116 and with server 1122 via a communication channel 1124. Server 1122 may operate to execute software instructions and store information.

Network region 1102 includes a multiplicity of clients with a sampling denoted as a client 1126 and a client 1128. Client 1126 includes a networking device 1134, a processor 1136, a GUI 1138 and an interface device 1140. Non-limiting examples of devices for GUI 1138 include monitors, televisions, cellular telephones, smartphones, and PDAs (Personal Digital Assistants). Non-limiting examples of interface device 1140 include pointing device, mouse, trackball, scanner, and printer. Networking device 1134 may communicate bi-directionally with global network 1010 via communication channel 1112 and with processor 1136 via a communication channel 1142. GUI 1138 may receive information from processor 1136 via a communication channel 1144 for presentation to a user for viewing. Interface device 1140 may operate to send control information to processor 1136 and to receive information from processor 1136 via a communication channel 1146. Network region 1104 includes a multiplicity of clients with a sampling denoted as a client 1130 and a client 1132. Client 1130 includes a networking device 1148, a processor 1150, a GUI 1152 and an interface device 1154. Non-limiting examples of devices for GUI 1138 include monitors, televisions, cellular telephones, smartphones, and PDAs (Personal Digital Assistants). Non-limiting examples of interface device 1140 include pointing devices, mousse, trackballs, scanners, and printers. Networking device 1148 may communicate bi-directionally with global network 1010 via communication channel 1114 and with processor 1150 via a communication channel 1156. GUI 1152 may receive information from processor 1150 via a communication channel 1158 for presentation to a user for viewing. Interface device 1154 may operate to send control information to processor 1150 and to receive information from processor 1150 via a communication channel 1160.

For example, consider the case where a user interfacing with client 1126 may want to execute a networked application. A user may enter the IP (Internet Protocol) address for the networked application using interface device 1140. The IP address information may be communicated to processor 1136 via communication channel 1146. Processor 1136 may then communicate the IP address information to networking device 1134 via communication channel 1142. Networking device 1134 may then communicate the IP address information to global network 1010 via communication channel 1112. Global network 1010 may then communicate the IP address information to networking device 1120 of server device 1012 via communication channel 1116. Networking device 1120 may then communicate the IP address information to server 1122 via communication channel 1124. Server 1122 may receive the IP address information and after processing the IP address information may communicate return information to networking device 1120 via communication channel 1124. Networking device 1120 may communicate the return information to global network 1010 via communication channel 1116. Global network 1010 may communicate the return information to networking device 1134 via communication channel 1112. Networking device 1134 may communicate the return information to processor 1136 via communication channel 1142. Processor 1146 may communicate the return information to GUI 1138 via communication channel 1144. User may then view the return information on GUI 1138.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC § 112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC § 112 (6).

It is noted that according to USA law, all claims must be set forth as a coherent, cooperating set of limitations that work in functional combination to achieve a useful result as a whole. Accordingly, for any claim having functional limitations interpreted under 35 USC § 112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC § 112 (6) is/(are) dependent on one or more remote servers located outside the USA, it is intended that each such recited function under 35 USC § 112 (6) is to be interpreted as the function of the local system receiving the remotely generated information required by a locally implemented claim limitation, wherein the structures and or steps which enable, and breathe life into the expression of such functions claimed under 35 USC § 112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC § 112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent, or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporated by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to be incorporated by reference in the instant application.

Having fully described at least one embodiment of the present invention, other equivalent or alternative methods of implementing a seamless and frictionless goods delivery system according to the present invention will be apparent to those skilled in the art. Various aspects of the invention have been described above by way of illustration, and the specific embodiments disclosed are not intended to limit the invention to the particular forms disclosed. The particular implementation of the seamless and frictionless goods delivery system may vary depending upon the particular context or application. By way of example, and not limitation, the seamless and frictionless goods delivery system described in the foregoing were principally directed to airline goods delivery system implementations; however, similar techniques may instead be applied to goods delivery system using any known transport system that can work with the enterprise system disclosed herein, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requires an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A non-transitory computer-readable storage medium with an executable program stored thereon, wherein the executable program is executed by at least one or more processors to perform a method comprising:
downloading an enterprise application to a computer device;
registering at an enterprise platform with the enterprise application;
requesting a service with said enterprise platform, wherein the service comprises:
picking up a luggage or package at a pick-up point; and
delivering the luggage or package at a drop off point;
scheduling an assisted pick-up of the luggage or package;
confirming the pick-up of the luggage or package at the pick-up point assigned by said enterprise platform;
scheduling an assisted delivery of the luggage or package; and
confirming delivery of the luggage or package at the drop-off point assigned by said enterprise platform.

2. The method characterized by claim 1, wherein said assisted pick-up of the luggage or package includes pick-up of the luggage or package at a departure area of an airport.

3. The method characterized by claim 2, wherein said assisted pick-up of the luggage or package is confirmed at a check-in terminal at the airport assigned by the enterprise platform.

4. The method characterized by claim 3, wherein said assisted delivery of the luggage or package includes delivery of the luggage or package at an arrival area of a destination airport.

5. The method characterized by claim 4, wherein said assisted delivery of the luggage or package is confirmed at an arrival terminal of the destination airport assigned by said enterprise platform or confirmed with said enterprise platform running on said computer device.

6. The method characterized by claim 1, in which said registering at said enterprise platform comprises capturing at least one of, user information and luggage or baggage information with a user information capture module including:
presenting one or more questions;
recording answers to the one or more questions; and
capturing visual information of the luggage or baggage using a camera.

7. The method characterized by claim 6, in which said registering at said enterprise platform further comprises capturing airline information in accordance with an airline information module including at least one of, an airline itinerary, a delivery statistic, and a safety statistic.

8. The method characterized by claim 7, in which said registering at said enterprise platform further comprises capturing traveler information including presenting questions on the display module which the traveler answers using miscellaneous data capture device.

9. The method characterized by claim 1, further comprising capturing information on delivery assistants or couriers including presenting questions on the display module and collecting answers with a miscellaneous data capture device using a delivery assistance module.

10. The method characterized by claim 1, further comprising coordinating the request for assisted pick-up of the luggage or package with a registered airline and the delivery assistants or couriers using an assigning and coordinating module.

11. A system comprising:
means for downloading an enterprise application;
means for registering with an enterprise platform;
means for capturing at least one of, user information and luggage or baggage information;
means for capturing traveler information;
means for capturing airline information;
means for scheduling an assisted pick-up of the luggage or package;
means for confirming the pick-up of the luggage or package;
means for scheduling an assisted delivery of the luggage or package at a drop-off point;
means for confirming delivery of the luggage or package at the drop-off point; and
means for coordinating the assisted pick-up and drop-off of the luggage or package with a registered airline and delivery assisters or couriers.

12. A method comprising:
a non-transitory computer-readable storage medium with an executable program stored thereon, wherein the executable program is executed by said at least one or more processors to perform the method, the method comprises:
downloading an enterprise application to a computer device;
registering at an enterprise platform with the enterprise application;
scheduling a service pick-up of the luggage or package;
confirming the service pick-up of the luggage or package at the pick-up point assigned by said enterprise platform;
scheduling a service delivery of the luggage or package;
confirming the service delivery of the luggage or package at the drop-off point assigned by said enterprise platform; and
coordinating the request for service pick-up and drop-off of the luggage or package with a registered airline and delivery assisters or couriers.

13. The method characterized by claim 12, wherein said service pick-up of the luggage or package includes pick-up of the luggage or package at a departure area of an airport.

14. The method characterized by claim 13, wherein said service pick-up of the luggage or package is confirmed at a check-in terminal at the airport assigned by the enterprise platform.

15. The method characterized by claim 14, wherein said service delivery of the luggage or package includes delivery of the luggage or package at an arrival area of a destination airport.

16. The method characterized by claim 15, wherein said service delivery of the luggage or package is confirmed at an arrival terminal of the destination airport assigned by said enterprise platform or confirmed with said enterprise platform running on said computer device.

17. The method characterized by claim 12, in which said registering at said enterprise platform comprises capturing at least one of, user information and luggage or baggage information with a user information capture module including:
presenting one or more questions;
recording answers to the one or more questions; and
capturing visual information of the luggage or baggage using a camera.

18. The method characterized by claim 17, in which said registering at said enterprise platform further comprises capturing airline information in accordance with an airline information module including at least one of, an airline itinerary, a delivery statistic, and a safety statistic.

19. The method characterized by claim 18, in which said registering at said enterprise platform further comprises capturing traveler information including presenting questions on the display module which the traveler answers using miscellaneous data capture device.

20. The method characterized by claim 19, further comprising capturing information on delivery assistants or couriers including presenting questions on the display module and collecting answers with a miscellaneous data capture device using a delivery assistance module.
